(19) United States
(12) Patent Application Publication
(10) Pub. No.: US 2013/0013381 A1
(43) Pub. Date: Jan. 10, 2013

(54) DISPATCH SYSTEM FOR ALLOWING A USER TO CALL A HIRE VEHICLE

(75) Inventor: Neng LIU, Hsinchu Hsien (TW)

(73) Assignee: Mitac International Corp., Taoyuan County (TW)

(21) Appl. No.: 13/539,942

(22) Filed: Jul. 2, 2012

(30) Foreign Application Priority Data
Jul. 4, 2011 (TW) 100123495

(51) Int. Cl. G07B 15/02

(52) U.S. Cl. 705/13

(57) ABSTRACT

A dispatch system includes a plurality of vehicle-end devices, a client-end device, and a dispatch server. The vehicle-end devices are disposed at respective hire vehicles. The client-end device is operable to send out passenger information. The dispatch server receives the passenger information, and stores a map database. The dispatch server is operable to find a matching one of the hire vehicles, to transmit to the client-end device information of the matching one of the hire vehicles so as to allow the client-end device to display with an indicator that indicates the current position of the matching one of the hire vehicles, and to dispatch the matching one of the hire vehicles to the user.

### CROSS-REFERENCE TO RELATED APPLICATION

This application claims priority of Taiwanese Application No. 100123495, filed on Jul. 4, 2011.

### BACKGROUND OF THE INVENTION

1. Field of the Invention

The invention relates to a dispatch system, more particularly to a dispatch system for allowing a user to call a hire vehicle.

2. Description of the Related Art

Generally, a hire vehicle (e.g., a taxicab) is hired by a passenger via waving at a side of a street. However, the passenger may spend a considerably longtime waiting for a taxicab to approach, especially in uptown areas.

Many conventional dispatch systems are implemented by taxi service providers to address such inconvenience, making hiring of a taxicab through phone calls or online orders available to passengers. Nonetheless, after the hire of a taxicab is made, the conventional dispatch systems only provide the passengers with the license plate number of an oncoming taxicab and an estimated time of arrival (ETA). Such ETA may be inaccurate since the driver of the oncoming taxicab may not be able to locate the passenger, or the traffic flow may prevent the taxicab from arriving on time.

### SUMMARY OF THE INVENTION

Therefore, the object of the present invention is to provide a dispatch system that allows the user to call a hire vehicle that matches the preference of the user in terms of a vehicle model, and that is operable to provide the user with real-time position information about the oncoming hire vehicle.

Accordingly, a dispatch system of the present invention is for allowing a user to call a hire vehicle. The dispatch system comprises a plurality of vehicle-end devices, a client-end device, and a dispatch server.

The vehicle-end devices are disposed at respective hire vehicles. Each of the vehicle-end devices includes a memory unit for storing model information relevant to a respective one of the hire vehicles, and is operable to send out the model information. Each of the vehicle-end devices is further operable to send out real-time position information associated with a current position thereof.

The client-end device is operable by the user to send out passenger information indicating a departure position and a required vehicle model.

The dispatch server is operable to communicate with each of the vehicle-end devices for receiving the model information and the real-time position information and to communicate with the client-end device for receiving the passenger information. The dispatch server includes a memory device for storing a map database having a plurality of maps. The dispatch server further includes a processor. The processor of the dispatch server is operable to compare the passenger information with the model information and the real-time position information to find a matching one of the hire vehicles that has the model information and the current position respectively matching the required vehicle model and the departure position of the passenger information. The processor of the dispatch server is further operable to transmit to the client-end device the model information of the matching one of the hire vehicles and the real-time position information of a dispatched one of the vehicle-end devices that is disposed at the matching one of the hire vehicles as well as a corresponding one of the maps, which corresponds to the real-time position information of the dispatched one of the vehicle-end devices, so as to allow the client-end device to display the corresponding one of the maps with an indicator that indicates the current position and that is associated with the model information of the matching one of the hire vehicles, and to dispatch the matching one of the hire vehicles to the user.

According to another aspect of this invention, a dispatch server for vehicle dispatching a hire vehicle to a user is provided. The dispatch server is operable to communicate with a client-end device operable by the user to send out passenger information including a departure position and a required vehicle model. The dispatch server is further operable to communicate with a plurality of vehicle-end devices which are disposed at respective hire vehicles. Each of the vehicle-end devices stores model information about a respective one of the hire vehicles, and is operable to send out the model information and real-time position information associated with a current position thereof. The dispatch server comprises a memory device and a processor.

The memory device is for storing a map database having a plurality of maps.

The processor is coupled to the memory device and is operable to compare the passenger information with the model information and the real-time position information to find a matching one of the hire vehicles that has the model information and the current position respectively matching the required vehicle model and the departure position of the passenger information. The processor is further operable to transmit to the client-end device the model information of the matching one of the hire vehicles and the real-time position information of a dispatched one of the vehicle-end devices that is disposed at the matching one of the hire vehicles. The processor is operable to further transmit a corresponding one of the maps, which corresponds to the real-time position information of the dispatched one of the vehicle-end devices, so as to allow the client-end device to dynamically display the corresponding one of the maps with an indicator that indicates the current position and that is associated with the model information of the matching one of the hire vehicles. The processor is further operable to dispatch the matching one of the hire vehicles to the user.

According to still another aspect of this invention, a client-end device operable to communicate with a dispatch server for dispatching a hire vehicle to a user who is associated with the client-end device is provided.

The dispatch server stores a plurality of maps and is operable to communicate with a plurality of vehicle-end devices which are disposed at respective hire vehicles. Each of the vehicle-end devices stores model information relevant a respective one of the hire vehicles, and is operable to send out the model information and real-time position information associated with a current position thereof. The client-end device comprises a memory unit and a processor.

The memory unit has instructions of a dedicated application program. The processor is coupled to the memory unit and is operable to execute the dedicated application program to:

allow user operation to send out passenger information about a departure position and a required vehicle model to the dispatch server;

receive the model information of a matching one of the hire vehicles that is found by the dispatch server after comparing the passenger information with the model information and the real-time position information and that has the model information and the current position respectively matching the required vehicle model and the departure position of the passenger information;

receive the real-time position information of a dispatched one of the vehicle-end devices that is disposed at the matching one of the hire vehicles and a corresponding one of the maps, which corresponds to the real-time position information of the dispatched one of the vehicle-end devices; and

dynamically display the corresponding one of the maps with an indicator that indicates the current position and that is associated with the model information of the matching one of the hire vehicles.

According to yet another aspect of this invention, a vehicle-end device disposed at a hire vehicle is provided. The vehicle-end device is operable to communicate with a dispatch server for dispatching the hire vehicle to a user who is associated with a client-end device operable by the user to send out passenger information indicating a departure position and a required vehicle model. The dispatch server stores a plurality of maps and is operable to communicate with the client-end device for receiving the passenger information. The vehicle-end device comprises a memory unit for storing model information relevant to the hire vehicle and is further operable to send out the model information and real-time position information associated with a current position thereof to the dispatch server so as to allow the dispatch server to:

compare the passenger information with the model information and the real-time position information to determine whether the hire vehicle has the model information and the current position respectively matching the required vehicle model and the departure position of the passenger information; and

when the hire vehicle has the model information and the current position respectively matching the required vehicle model and the departure position of the passenger information, transmit to the client-end device the model information of the hire vehicle and the real-time position information as well as a corresponding one of the maps, which corresponds to the real-time position information of the vehicle-end device, so as to allow the client-end device to dynamically display the corresponding one of the maps with an indicator that indicates the current position and that is associated with the model information of the hire vehicle.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of a preferred embodiment of a dispatch system according to the invention; and

FIG. 2 is a flow chart illustrating the operation of the dispatch system of the preferred embodiment.

### DETAILED DESCRIPTION OF THE PREFERRED EMBODIMENT

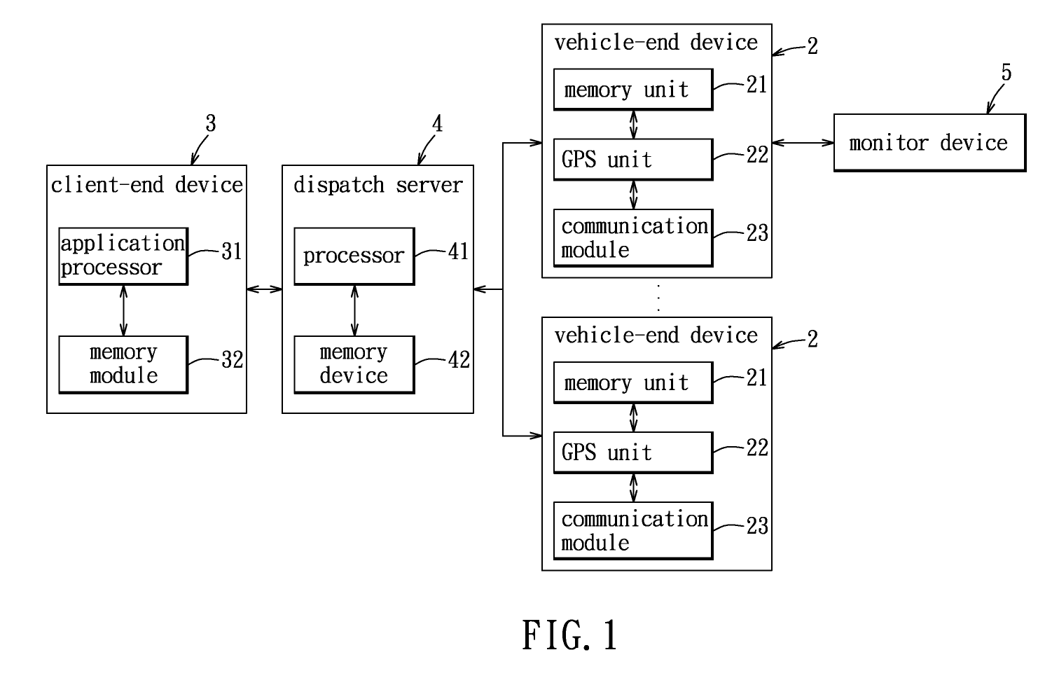

As shown in FIG. 1, the preferred embodiment of a dispatch system for vehicle hire according to the present invention allows a user to call a hire vehicle (e.g., a taxicab, a rental car, etc.) from a vehicle hire service provider. The dispatch system includes a plurality of vehicle-end devices 2, at least one client-end device 3, and a dispatch server 4 operable to communicate with the vehicle-end devices 2 and the client-end device 3.

In this embodiment, the vehicle-end devices 2 are disposed at respective hire vehicles (e.g., taxicabs in this embodiment) of the vehicle hire service provider, and each of the vehicle-end devices 2 includes a memory unit 21 storing a model information relevant to a respective one of the hire vehicles, a global positioning system (GPS) unit 22 and a communication module 23. The GPS unit 22 is operable to obtain real-time position information associated with a current position of the vehicle-end device 2 (i.e., a current position of the respective one of the hire vehicles). The communication module 23 of each of the vehicle-end devices 2 is operable to send out the model information and the real-time position information to the dispatch server 4. The model information stored in the memory unit 21 of each of the vehicle-end devices 2 includes a manufacturer, a model and a manufacturing year of the respective one of the hire vehicles. For example, the model information can be in the formof (Toyota, Camry, 2005) or (Honda, Accord, 2010).

The client-end device 3 is associated with and possessed by the user, and is a smart phone installed with a dedicated application program in this embodiment. The client-end device 3 includes a memory module 32 for storing instructions of the dedicated application program therein, and an application processor 31 for executing the dedicated application program to allow the user to send out passenger information. Specifically, the passenger information includes a departure position, a destination and a required vehicle model that is associated with the preference of the user. It is noted that the client-end device 3 can be other electronic devices that are compatible with the dedicated application program in other embodiments of the invention, and is not limited to the smart phone as described in the present disclosure.

The dispatch server 4 includes a processor 41 and a memory device 42. The memory device 42 is provided with a map database that includes a plurality of maps. The processor 41 is operable to receive the passenger information from the client-end device 3, and to compare the passenger information with the model information and the real-time position information to find a matching one of the hire vehicles that has the model information and the current position respectively matching the required vehicle model and the departure position of the passenger information. Then, the processor 41 is operable to transmit to the client-end device 3 the model information of the matching one of the hire vehicles and the real-time position information of a dispatched one of the vehicle-end devices 2 that is disposed at the matching one of the hire vehicles as well as a corresponding one of the maps. The corresponding one of the maps corresponds to the real-time position information of the dispatched one of the vehicle-end devices 2. As a result, the client-end device 3 is operable to display the corresponding one of the maps with an indicator that indicates the current position of the matching one of the hire vehicles and that is associated with the model information of the matching one of the hire vehicles. Then, the matching one of the hire vehicles is dispatched to the user.

It is worth noting that, the dispatch server 4 is operable to receive the real-time position information from each of the vehicle-end devices 2 continuously, and simultaneously transmit to the client-end device 3 the real-time position information of the dispatched one of the vehicle-end devices 2 that is disposed at the matching one of the hire vehicles. Accordingly, the client-end device 3 is operable to dynamically display the corresponding one of the maps with the indicator based on the latest received real-time position information. Such configuration can provide the user with a precise location of the matching one of the hire vehicles in real time.

In this embodiment, the dispatch system also provides the user with a more accurate estimated time of arrival (ETA). Specifically, the processor 41 of the dispatch server 4 is operable to continuously estimate the ETA of the matching one of the hire vehicles arriving at the departure position according to the departure position of the passenger information and the real-time position information. The processor 41 of the dispatch server 4 is also operable to continuously transmit the ETA to the client-end device 3 so as to allow the client-end device 3 to display and to update the indicator with the ETA in real time.

Moreover, for the user's safety, the dispatch system introduces a safety monitoring mechanism. For example, in this embodiment, the dispatch system further includes a monitor device 5 that is associated with the client-end device 3, and that is in the possession of a third-party (preferably a family member or a friend of the user). The dispatched one of the vehicle-end devices 2 that is disposed at the matching one of the hire vehicles is operable to send out a pick-up signal upon arriving at the departure position, and to send out a drop-off signal upon leaving from the client-end device 3. The drop-off signal may be triggered by, for example, the client-end device 3 being away from the dispatched one of the vehicle-end devices 2 by more than a predetermined distance. Alternatively, the drop-off signal may be actively triggered by a driver of the matching one of the hire vehicles when the user leaves the matching one of the hire vehicles. On the other hand, the monitor device 5 is operable to communicate with the dispatched one of the vehicle-end devices 2 for receiving the pick-up signal and the drop-off signal. The operation of the safety monitoring mechanism will now be described in the following.

When the hire vehicle arrives at the departure position and the user boards the hire vehicle, the vehicle-end device 2 of the hire vehicle is operable to send out the pick-up signal to the monitor device 5 that is associated with the client-end device 3. Afterward, when the hire vehicle is at the destination and the user leaves from the hire vehicle, the vehicle-end device 2 of the hire vehicle is operable to send out the drop-off signal to the monitor device 5.

In another aspect, in order to clear out the controversy that the driver may deliberately make a detour for additional fare, a solution is provided in this embodiment. Specifically, the processor 41 of the dispatch server 4 is further operable to plan a predetermined route for the matching one of the hire vehicles according to the departure position and the destination of the passenger information, to store the predetermined route in the memory device 42, and to provide the user with the predetermined route. With such configuration, the predetermined route is disclosed to the user, ensuring that no additional fare is charged from deliberate detour.

In another aspect, the processor 41 of the dispatch server 4 is further operable, in response to receipt of the pick-up signal, to record a series of the current positions of the dispatched one of the vehicle-end devices 2 according to the real-time position information until receipt of the drop-off signal so as to obtain and to store an actual route of the matching one of the hire vehicles in the memory device 42. Accordingly, the vehicle hire service provider may track the actual route of the hire vehicle so as to estimate an actual fare charged to the user for preventing the driver from fraudulently repaying the vehicle hire service provider a short fare.

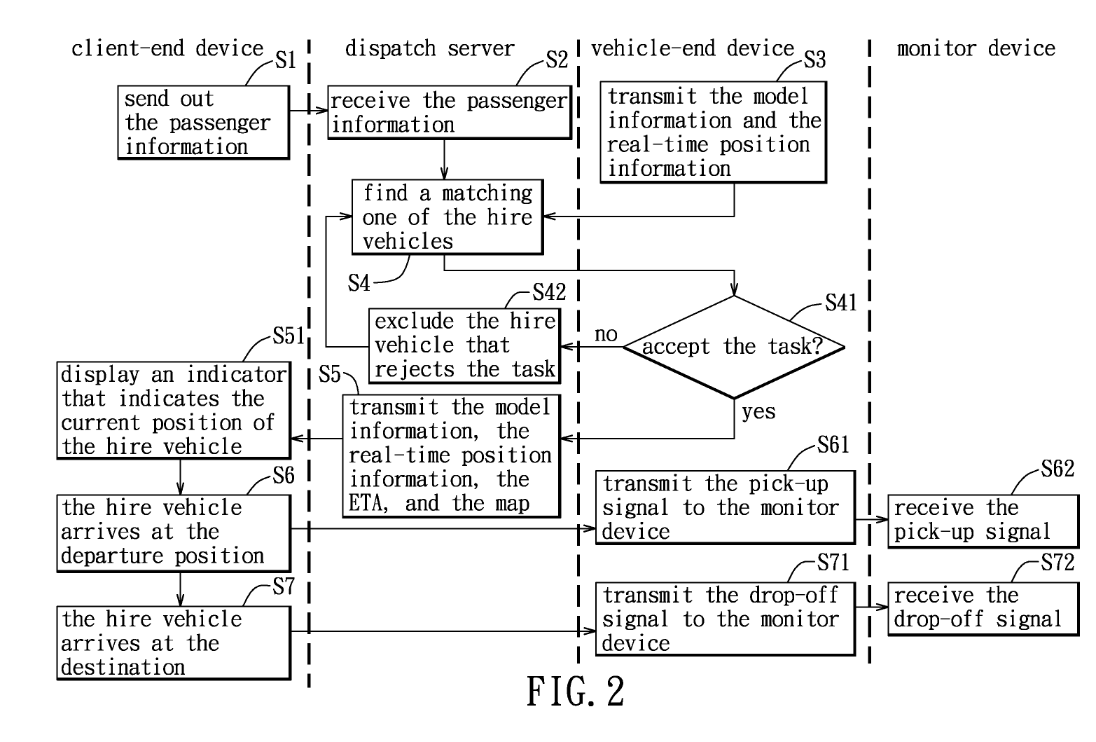

Referring to FIG. 2, steps of a method for calling a hire vehicle using the aforementioned dispatch system will now be described in the succeeding paragraphs.

In step S1, the user operates the client-end device 3 to execute the dedicated application program installed in the client-end device 3 to communicate with the dispatch server 4 of the vehicle hire service provider, and to send out the passenger information to the dispatch server 4.

Then, the dispatch server 4 is operable to receive the passenger information in step S2. Each of the vehicle-end devices 2 is operable to transmit the model information and the real-time position information to the dispatch server 4 in step S3. Thus, the processor 41 of the dispatch server 4 is operable, in step S4, to compare the passenger information with the model information and the real-time position information to find a matching one of the hire vehicles that has the model information and the current position respectively matching the required vehicle model and the departure position of the passenger information.

It is worth noting that, it is not necessary for the user to provide all the aforementioned data of the passenger information. For example, the user may not provide the required vehicle model and/or the destination.

When a matching one of the hire vehicles is found, in step S41, the processor 41 is operable to send a notification to the vehicle-end device 2 of the matching one of the hire vehicles to provide a task to the driver of the matching one of the hire vehicles and the driver can decide whether or not to accept the task. The flow goes to step S5 when the driver of the matching one of the hire vehicles accepts the task, and goes to step S42 when otherwise. In step S42, the processor 41 is operable to exclude said one of the hire vehicles, which does not accept the task, and the flow goes to step S4 subsequently.

In step S5, the dispatch server 4 is operable to transmit the model information, the real-time position information, the ETA, as well as a corresponding one of the maps to the client-end device 3. The information transmitted by the dispatch server 4 allows the client-end device 3 to display, in step S51, the corresponding one of the maps with an indicator that indicates the current position of the matching one of the hire vehicles and that is associated with the model information of the matching one of the hire vehicles, and to update the indicator with the ETA and the current position in real time. Thus, the user is informed with the necessary information about the oncoming hire vehicle, i.e., the matching one of the hire vehicles accepting the task.

When the hire vehicle arrives at the departure position and the user boards the hire vehicle in step S6, the aforementioned safety monitoring mechanism is executed subsequently. The vehicle-end device 2 is operable to transmit the pick-up signal to the monitor device 5 that is associated with the client-end device 3 in step S61, and the monitor device 5 is operable to receive the pick-up signal in step S62. Then, in step S62, the vehicle-end device 2 is operable to transmit continuously a tracking signal to the monitor device 5, and the pick-up signal serves as a trigger for the monitor device 5 to receive continuously the tracking signal. Similar to the information transmitted in step S5, the tracking signal allows the monitor device 5 to display the corresponding one of the maps with the indicator that indicates the current position of the hire vehicle carrying the user.

Then, after the hire vehicle arrives at the destination and the user leaves the hire vehicle in step S7, the vehicle-end device 2 is operable to transmit the drop-off signal to the monitor device 5 in step S71, and the monitor device 5 is operable to receive the drop-off signal in step S72. The drop-off signal serves as a trigger for the monitor device 5 to stop receiving the tracking signal from the vehicle-end device 2.

To sum up, the dispatch system of the present invention introduces the dispatch server 4 that is operable to receive the passenger information associated with the preference of the user and to compare the passenger information with the model information and the real-time position information to find a matching one of the hire vehicles that has the model information and the current position respectively matching the required vehicle model and the departure position of the passenger information, so as to dispatch the matching one of the hire vehicles to the user. The dispatch server 4 is further operable to continuously receive the real-time position information from the vehicle-end device 2 and to continuously transmit the same to the client-end device 3, so as to allow the client-end device 3 to dynamically display the indicator on the map. Moreover, the monitor device 5 allows a third party to be informed with the real-time position of the hire vehicle carrying the user, thereby ensuring the safety of the user.

While the present invention has been described in connection with what is considered the most practical and preferred embodiment it is understood that this invention is not limited to the disclosed embodiment but is intended to cover various arrangements included within the spirit and scope of the broadest interpretation so as to encompass all such modifications and equivalent arrangements.

What is claimed is:

1. A dispatch system for allowing a user to call a hire vehicle, said dispatch system comprising:
a plurality of vehicle-end devices to be disposed at respective hire vehicles, each of said vehicle-end devices including a memory unit for storing model information relevant to a respective one of the hire vehicles and being operable to send out the model information and real-time position information associated with a current position thereof;
a client-end device operable by the user to send out passenger information including a departure position and a required vehicle model; and
a dispatch server operable to communicate with each of said vehicle-end devices for receiving the model information and the real-time position information and to communicate with said client-end device for receiving the passenger information, said dispatch server including a memory device for storing a map database having a plurality of maps, and a processor operable to
compare the passenger information with the model information and the real-time position information to find a matching one of the hire vehicles that has the model information and the current position respectively matching the required vehicle model and the departure position of the passenger information,
transmit to said client-end device the model information of the matching one of the hire vehicles and the real-time position information of a dispatched one of said vehicle-end devices that is disposed at the matching one of the hire vehicles as well as a corresponding one of the maps, which corresponds to the real-time position information of the dispatched one of the vehicle-end devices, so as to allow said client-end device to display the corresponding one of the maps with an indicator that indicates the current position and that is associated with the model information of the matching one of the hire vehicles, and
dispatch the matching one of the hire vehicles to the user.

2. The dispatch system as claimed in claim 1, wherein said dispatch server is operable to continuously communicate with the dispatched one of said vehicle-end devices that is disposed at the matching one of the hire vehicles for continuously receiving and transmitting the real-time position information to said client-end device, to thereby allow said client-end device to dynamically display the corresponding one of the maps with the indicator.

3. The dispatch system as claimed in claim 2, wherein said processor of said dispatch server is further operable to continuously estimate, according to the departure position of the passenger information and the real-time position information, an estimated time of arrival (ETA) of the matching one of the hire vehicles arriving at the departure position, and to continuously transmit the ETA to said client-end device so as to allow said client-end device to display and to update the indicator with the ETA in real time.

4. The dispatch system as claimed in claim 1, further comprising a monitor device associated with said client-end device,
wherein the dispatched one of said vehicle-end devices that is disposed at the matching one of the hire vehicles is operable to send out a pick-up signal upon arriving at the departure position, and to send out a drop-off signal upon leaving from said client-end device,
wherein said monitor device is operable to communicate with the dispatched one of said vehicle-end devices for receiving the pick-up signal and the drop-off signal.

5. The dispatch system as claimed in claim 4, wherein the dispatched one of said vehicle-end devices that is disposed at the matching one of the hire vehicles is further operable to transmit the pick-up signal and the drop-off signal to said dispatch server, and said processor of said dispatch server is further operable, in response to receipt of the pick-up signal, to record a series of the current positions of the dispatched one of said vehicle-end devices according to the real-time position information until receipt of the drop-off signal so as to obtain and to store an actual route of the matching one of the hire vehicles in said memory device.

6. The dispatch system as claimed in claim 1, wherein each of said vehicle-end devices further includes a global positioning system (GPS) module operable to detect the current position and to generate the real-time position information, and a communication module operable to transmit the real-time position information to said dispatch server.

7. The dispatch system as claimed in claim 1, wherein the model information stored in each of said vehicle-end devices includes at least one of a manufacturer, a model and a manufacturing year of the respective one of the hire vehicles.

8. The dispatch system as claimed in claim 1, wherein said client-end device is further operable by the user to set and send out a destination.

9. The dispatch system as claimed in claim 8, wherein said processor of said dispatch server is further operable to plan a predetermined route for the matching one of the hire vehicles according to the departure position and the destination, and to store the predetermined route in said memory device.

10. A dispatch server for dispatching a hire vehicle to a user, said dispatch server being operable to communicate with a client-end device operable by the user to send out passenger information including a departure position and a required vehicle model, and with a plurality of vehicle-end devices which are disposed at respective hire vehicles and each of which stores model information relevant to a respective one of the hire vehicles and is operable to send out the model information and real-time position information associated with a current position thereof, said dispatch server comprising:
a memory device for storing a map database having a plurality of maps; and
a processor coupled to said memory device and operable to
compare the passenger information with the model information and the real-time position information to find a matching one of the hire vehicles that has the model information and the current position respectively matching the required vehicle model and the departure position of the passenger information,
transmit to the client-end device the model information of the matching one of the hire vehicles and the real-time position information of a dispatched one of the vehicle-end devices that is disposed at the matching one of the hire vehicles as well as a corresponding one of the maps, which corresponds to the real-time position information of the dispatched one of the vehicle-end devices, so as to allow the client-end device to dynamically display the corresponding one of the maps with an indicator that indicates the current position and that is associated with the model information of the matching one of the hire vehicles, and
dispatch the matching one of the hire vehicles to the user.

11. The dispatch server as claimed in claim 10, wherein said processor is further operable to plan a predetermined route for the matching one of the hire vehicles according to the departure position and a destination set by the user through the client-end device, and to store the predetermined route in said memory device.

12. A client-end device operable to communicate with a dispatch server for dispatching a hire vehicle to a user who is associated with said client-end device, the dispatch server storing a plurality of maps and being operable to communicate with a plurality of vehicle-end devices which are disposed at respective hire vehicles and each of which stores model information relevant to a respective one of the hire vehicles and is operable to send out the model information and real-time position information associated with a current position thereof, said client-end device comprising:
a memory unit having instructions of a dedicated application program; and
a processor coupled to said memory unit and operable to execute the dedicated application program to
allow user operation to send out passenger information about a departure position and a required vehicle model to the dispatch server,
receive the model information of a matching one of the hire vehicles that is found by the dispatch server after comparing the passenger information with the model information and the real-time position information and that has the model information and the current position respectively matching the required vehicle model and the departure position of the passenger information,
receive the real-time position information of a dispatched one of the vehicle-end devices that is disposed at the matching one of the hire vehicles and a corresponding one of the maps, which corresponds to the real-time position information of the dispatched one of the vehicle-end devices, and
dynamically display the corresponding one of the maps with an indicator that indicates the current position and that is associated with the model information of the matching one of the hire vehicles.

13. The client-end device as claimed in claim 12, wherein said processor is operable to execute the dedicated application program to further allow user operation to set and send out a destination, such that the dispatch server is able to plan a predetermined route for the matching one of the hire vehicles according to the departure position and the destination.

14. A vehicle-end device to be disposed at a hire vehicle and operable to communicate with a dispatch server for dispatching the hire vehicle to a user who is associated with a client-end device operable by the user to send out passenger information including a departure position and a required vehicle model, the dispatch server storing a plurality of maps and being operable to communicate with the client-end device for receiving the passenger information,
said vehicle-end device comprising a memory unit for storing model information relevant to the hire vehicle and is further operable to send out the model information and real-time position information associated with a current position thereof to the dispatch server so as to allow the dispatch server to
compare the passenger information with the model information and the real-time position information to determine whether the hire vehicle has the model information and the current position respectively matching the required vehicle model and the departure position of the passenger information, and
when the hire vehicle has the model information and the current position respectively matching the required vehicle model and the departure position of the passenger information, transmit to the client-end device the model information of the hire vehicle and the real-time position information as well as a corresponding one of the maps, which corresponds to the real-time position information of the vehicle-end device, so as to allow the client-end device to dynamically display the corresponding one of the maps with an indicator that indicates the current position and that is associated with the model information of the hire vehicle.

15. The vehicle-end device as claimed in claim 14, wherein said vehicle-end device is operable to send out a pick-up signal upon arriving at the departure position, and a drop-off signal upon leaving the client-end device, to a monitor device remote from the client-end device.

16. The vehicle-end device as claimed in claim 15, wherein said vehicle-end device is further operable to transmit the pick-up signal and the drop-off signal to the dispatch server, such that the dispatch server is able operable, in response to receipt of the pick-up signal, to record a series of the current positions of said vehicle-end device according to the real-time position information until receipt of the drop-off signal so as to obtain and to store an actual route of the hire vehicle.

17. The vehicle-end device as claimed in claim 14, wherein said vehicle-end device further includes a global positioning system (GPS) module operable to detect the current position and to generate the real-time position information, and a communication module operable to transmit the real-time position information to the dispatch server.

18. The vehicle-end device as claimed in claim 14, wherein the model information stored in said memory unit includes at least one of a manufacturer, a model and a manufacturing year of the hire vehicle.
